(19) United States
(12) Patent Application Publication
(10) Pub. No.: US 2018/0074959 A1
(43) Pub. Date: Mar. 15, 2018

(54) NODE-BASED COMPUTING DEVICES WITH VIRTUAL CIRCUITS

(71) Applicant: Hewlett Packard Enterprise Development LP, Houston, TX (US)

(72) Inventors: Sheng Li, Palo Alto, CA (US); Jishen Zhao, San Jose, CA (US); Kevin T. Lim, La Honda, CA (US); Paolo Faraboschi, Palo Alto, CA (US)

(21) Appl. No.: 15/320,685

(22) PCT Filed: Jul. 22, 2014
(86) PCT No.: PCT/US2014/047703

§ 371 Date: Dec. 20, 2016

(51) Int. Cl. G06F 12/0815; G06F 1/32; G06F 13/40

(52) U.S. Cl. CPC G06F 12/0815; G06F 1/3287; G06F 2212/62; G06F 13/4022; G06F 2212/1008; G06F 1/3296

(57) ABSTRACT

According to an example, a node-based computing device includes memory nodes communicatively coupled to a processor node. The memory nodes may form a main memory address space for the processor node. The processor node may establish a virtual circuit through memory nodes. The virtual circuit may dedicate a path within the memory nodes. The processor node may then communicate a message through the virtual circuit. The memory nodes may forward the message according to the path dedicated by the virtual circuit.

### BACKGROUND

Computer networks and systems have become indispensable tools for modern business. Today terabytes or more of information on virtually every subject imaginable are stored and accessed across networks. Some applications, such as telecommunication network applications, mobile advertising, social media applications, etc., demand short response times for their data. As a result, new memory-based implementations of programs, such as in-memory databases, are being employed in an effort to provide the desired faster response times. These memory-intensive programs primarily rely on large amounts of directly addressable physical memory (e.g., random access memory) for storing terabytes of data rather than hard drives to reduce response times.

### BRIEF DESCRIPTION OF DRAWINGS

The following description illustrates various examples with reference to the following figures:

FIG. 1 is a diagram showing a node-based computing device, according to an example;

FIG. 2 is flowchart illustrating a method for using a virtual circuit to communicate messages in a node-based computing device, according to an example;

FIG. 3 is a flowchart illustrating a method for dynamically establishing a virtual circuit during run-time execution of a node-based computing device, according to an example;

FIG. 4 is a diagram showing the node-based computing device of FIG. 1 with voltage and frequency domains, according to an example; and

FIG. 5 is a block diagram of a computing device capable of communicating data using a virtual circuit, according to one example.

### DETAILED DESCRIPTION

For simplicity and illustrative purposes, the principles of this disclosure are described by referring mainly to examples thereof. In the following description, numerous specific details are set forth in order to provide a thorough understanding of the examples. It is apparent that the examples may be practiced without limitation to all the specific details. Also, the examples may be used together in various combinations.

A node-based computing device, according to an example, includes a processor node and memory nodes. The processor node may be communicatively coupled to the memory nodes via interconnects, such as point-to-point links. Further, the memory nodes may also be communicatively coupled to each other via interconnects, such as point-to-point links. Each memory node may be a memory subsystem including a memory controller and memory to store data. Each memory node may also include routing logic to route message data to a destination, which may be another memory node, processor node, or an input/output (“I/O”) port in the node-based computing device. Collectively, the memory nodes may provide a main memory address space for processor nodes.

Examples may use the memory nodes and the point-to-point links of a node-based computing device as a messaging fabric to communicate different protocol types carrying different types of messages, such as cache coherency messages, memory access command messages, and I/O messages, to given memory nodes, I/O ports, or processors of the node-based computing device.

In an example discussed herein, a node-based computing device may include processor nodes and memory nodes. Each memory node may include local memory. The local memory from the memory devices may collectively form a main memory address space of the node-based computing device. Point-to-point links may communicatively couple the memory nodes to one of the processor nodes, the memory nodes to another processor node, and the memory nodes to each other. One of the processor nodes may include a processor-side memory controller. The processor-side memory controller may establish a virtual circuit between the processor node and another processor node. The virtual circuit may dedicate a path through the memory nodes. The processor-side memory controller may communicate a cache coherency message to the another processor node using the path dedicated through the virtual circuit.

In another example, a processor node may detect a high use memory node. A high use memory node may be a memory node from memory nodes communicatively coupled to the processor node. The memory nodes may form an addressable memory space for the processor node. The processor node may establish a virtual circuit that dedicates a communication path from the processor node of the high use memory node. The processor node may also communicate subsequent messages through the virtual circuit. The memory nodes may forward the subsequent messages according to the dedicated path.

These and other examples are now described.

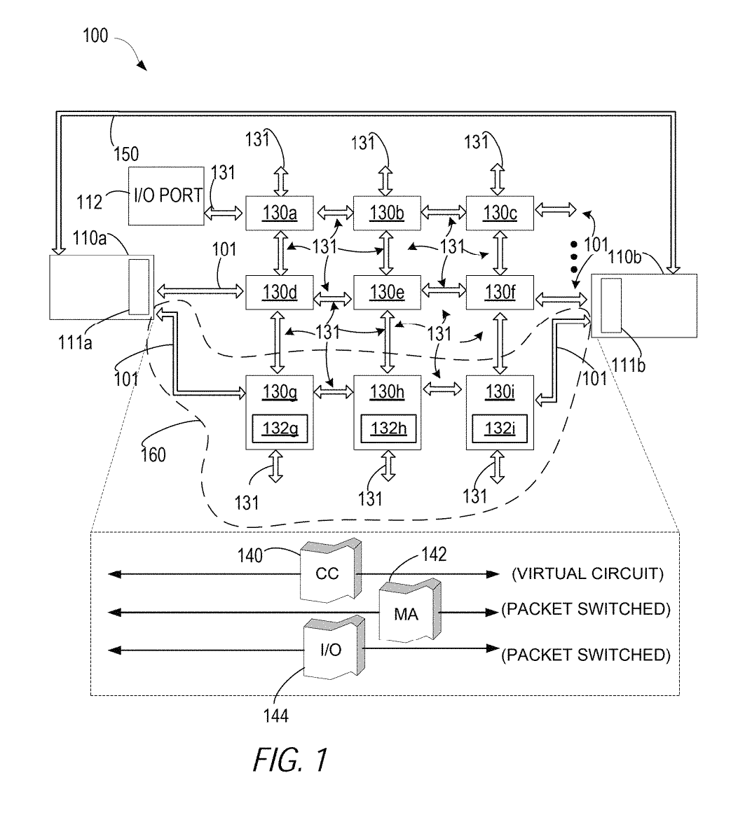

FIG. 1 is a diagram showing a node-based computing device 100, according to an example. The node-based computing device 100 may include processor nodes 110a,b and memory nodes 130a-i. The processor nodes 110a,b may be compute units that are configured to execute computer-readable instructions and operate on data stored in the memory nodes 130a-i. As FIG. 1 shows, the processor nodes 110a,b may include processor-side memory controllers 111a,b that are connected (directly or indirectly) to the memory nodes 130a-i of the node-based computing device 100 via point-to-point links 101. A point-to-point link may be a wire or other connection medium that links two circuits. In an example, a point-to-point link connects only two circuits which is unlike a shared bus or crossbar switches that connect more than two circuits or devices. A processor node and processor-side memory controller connected to the node-based computing device 100, such as 110a and 111a or 110b and 111b, may be provided on the same chip, or may be provided on separate chips. Also, more or fewer processor nodes, processor-side memory controllers and memory nodes than shown in FIG. 1 may be used in the node-based computing device 100. Also, an I/O port 112 may be connected to the node-based computing device 100. The I/O port 112 may be linked to a network device, a memory device, a data link or bus, a display terminal, a user input device, or the like.

The processor nodes 110a,b may, in some cases, be connected to each other with a direct processor-to-processor link 150, which may be a point-to-point link that provides a direct communication channel between the processor nodes 110a,b. In some cases, the processor nodes 110a,b may be configured to use the direct processor-to-processor link 150 to communicate high priority message data that is destined for each other. For example, the processor node 110a may send a cache coherency message destined for the processor node 110b through the direct processor-to-processor link 150 to avoid multiple hops through the memory nodes 130a-i.

The node-based computing device 100 may include memory nodes 130a-i that may also be connected together via point-to-point links 131, which are inter-node point-to-point links. Each memory node can operate as a destination of message data if the data to be accessed is stored at the memory node, and as a router that forwards message data along a path to an appropriate destination, such as another memory node, one of the processor nodes 110a,b, or the I/O port 112. For example, the processor-side memory controllers 111a,b can send memory access command messages, e.g., read, write, copy, etc., to the memory nodes 130a-i to perform memory access operations for the processor nodes 110a,b. Each memory node receiving message data may execute the command if that memory node is the destination or route the command to its destination memory node. The node-based computing device 100 may provide memory scalability through the point-to-point links 131 and through the ability to add memory nodes as needed, which may satisfy the memory capacity requirements of big-data workloads. Scaling up memory capacity in the node-based computing device 100 may involve, in some cases, cascading additional memory nodes.

The node-based computing device 100 may establish virtual circuits to provide quality of service (“QoS”) provisions for messages communicated through the node-based computing device 100. For example, the node-based computing device 100 may establish a virtual circuit, such as the virtual circuit 160, to provide performance bounds (and thereby, latency bounds) and band bandwidth allotments for given types of messages communicated through the memory nodes 130a-i. The virtual circuit 160 may be based on connection oriented packet switching, meaning that data may be delivered along the same memory node path. A possible advantage with a virtual circuit over connectionless packet switching is that in some cases bandwidth reservation during the connection establishment phase is supported, making guaranteed QoS possible. For example, a constant bit rate QoS class may be provided, resulting in emulation of circuit switching. Further, in some cases, less overhead may be used, since the packets (e.g., messages) are not routed individually and complete addressing information is not provided in the header of each data packet. Instead, a virtual channel identifier is included in each packet. Routing information may be transferred to the memory nodes during the connection establishment phase.

In FIG. 1, the virtual circuit 160 may be used to communicate cache coherency messages 140 from the processor node 110a to the processor node 110b. Accordingly, the node-based computing device 100 may provide QoS services to cache coherency messages using the virtual circuit, while memory access messages 142 and I/O messages 144 are transmitted to destination nodes within the node-based computing device 100 using packet switching. That is, subsequent messages sent from one node to another node may not necessarily travel through the same path of nodes.

As FIG. 1 shows, memory nodes may include memory-side memory controllers. For example, memory nodes 130g-i may include memory-side memory controllers 132g-i, respectively. The memory-side memory controllers 132g-i may include logic for accessing local memory (e.g., the memory-side memory controller 132g may include logic for accessing memory of the memory node 132) and routing messages to other nodes. A memory-side memory controller may include hardware, logic, and/or machine readable instructions stored on a storage device and executable by hardware. As just mentioned, a memory-side memory controller may perform the operations involved in executing memory access operations on memory local to a memory node. For example, the memory-side memory controller 132g can receive packets from other memory nodes, decode the packets to extract the memory access commands and enforce memory management mechanisms that may be implemented and the actual execution of the read, write, and block copy commands from local memory. To illustrate, after receiving a read command from the processor-side memory controller 111a of the processor node 111a, the memory-side memory controller 132g can fetch the data from local memory and notify the processor-side memory controller 111a that the data is ready to be accessed or directly sends a data packet with a transaction identifier and the requested data back to the processor-side memory controller 111a. These mechanisms depend on the specific type of the memory technology employed in the node; for example, the memory-side co-memory controller for DRAM is different from the co-memory controller for a DRAM stack, for flash memory, or for other forms of non-volatile memory.

In terms of routing, the memory-side memory controller 132g (or any other memory-side memory controller) may receive message data, determine whether the message data relate to a memory address mapped to local memory of the memory node 130g, and, if so, the memory-side memory controller 132g fetches data from the local memory. If the memory node 130g is not the destination, the memory-side memory controller 132g may send the message data to a next hop in the node-based computing device 100 toward the destination along one of the point-to-point links 131.

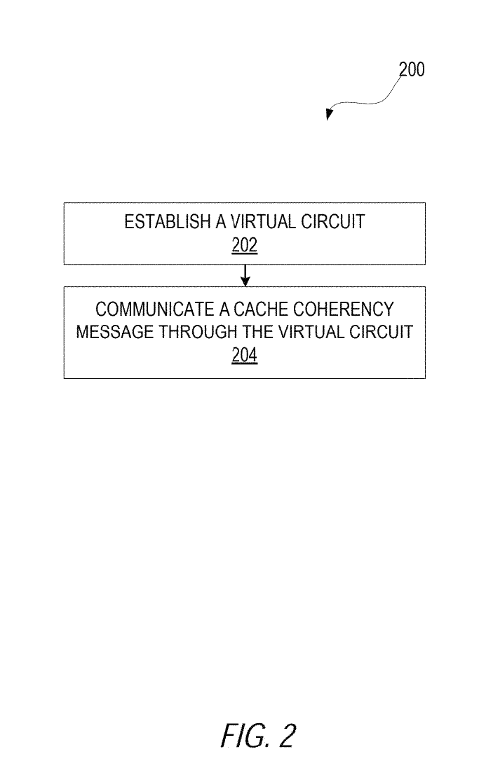

FIG. 2 is flowchart illustrating a method 200 for using a virtual circuit to communicate messages in a node-based computing device, according to an example. The method 200 may be performed by the modules, logic, components, or systems shown in FIG. 1 and, accordingly, is described herein merely by way of reference thereto. It will be appreciated that the method 200 may, however, be performed on any suitable hardware. The method of 200 may be performed by the node-based computing device 100 during system start-up to reserve or otherwise establish a virtual circuit usable to provide performance bounds (and thereby, latency bounds) and band bandwidth allotments for given types of messages communicated through the memory nodes 130a-i.

The method 200 may begin at operation 202 when the processor-side memory controller 111a establishes the virtual circuit 160. The virtual circuit 150 may include a path within the memory nodes between the memory processor node 110a and the processor node 110b. In some cases, the virtual circuit 150 may act as a dedicated path (e.g., memory nodes 130g-i, and corresponding point-to-point links) between the processor nodes 110a,b which may be used to communicate messages of a given type. Cache coherency messages are an example of a message type in which the virtual circuit 150 may be used to transmit. In some cases, establishing the virtual circuit 150 may involve the processor-side memory controller 111a reserving performance properties for the virtual circuit, such as a bandwidth or a priority. With virtual circuits, the processor-side memory controller 111a can also apply dynamic voltage and frequency scaling (“DVFS”) on different virtual channels in the node-based computing device to favorably deliver power to the memory nodes and links with high priority virtual channels, ensuring, in some cases, that messages are delivered in time to meet the QoS goals. In an example, the node-based computing device 100 can have a power budget, and DVFS can be applied to speed up the virtual circuits by increasing the voltage and/or frequency of the point-to-point links and memory nodes in those circuits. The power budget is maintained by adjusting (e.g., decreasing) the voltage and/or frequency of other paths (e.g., the point-to-point links and memory nodes) in the node-based computing device 100. Thus, the speed of the connections in the node-based computing device can vary while maintaining an overall energy budget. Note that applying DVFS in memory nodes 130a-i and point-to-point links 131 may lead to asynchronous network designs. To solve this problem, memory nodes can include buffers to allow for additional packet/message buffering at each node to compensate for the slower rates.

At operation 204, once the virtual circuit 150 between the processor nodes 110a,b is established, the processor node 110a may communicate a cache coherency message to the processor node 110b using the virtual circuit 150. As just discussed above, the virtual circuit 150 may be used to provide a dedicated path through the memory nodes 130a-i for a given type of message. Accordingly, according to the virtual circuit 160, the cache coherency message 140 may travel from the processor-side controller 111a to the memory-side memory controller 132g, to the memory-side memory controller 132h, to the memory-side memory controller 132i, and, finally, to the processor-side memory controller 111b.

As discussed above, the method of 200 may be performed by the node-based computing device 100 during system start-up to reserve or otherwise establish a virtual circuit usable to provide performance bounds (and thereby, latency bounds) and band bandwidth allotments for given types of messages communicated through the memory nodes 130a-i. In additional or alternative cases, a virtual circuit may be established dynamically during runtime. An example of a case where a virtual circuit can be established during runtime is where a processor node is likely to access a given memory node (e.g., the memory node is known to have data relevant to the processor node). For example, a virtual circuit can be established for a processor node executing a Hadoop worker compute node and the memory node holding its associated map/reduce data. The benefits of these virtual circuits may be to provide dedicated routing paths (and thereby, latency bounds) and bandwidth allotments for specific traffic.

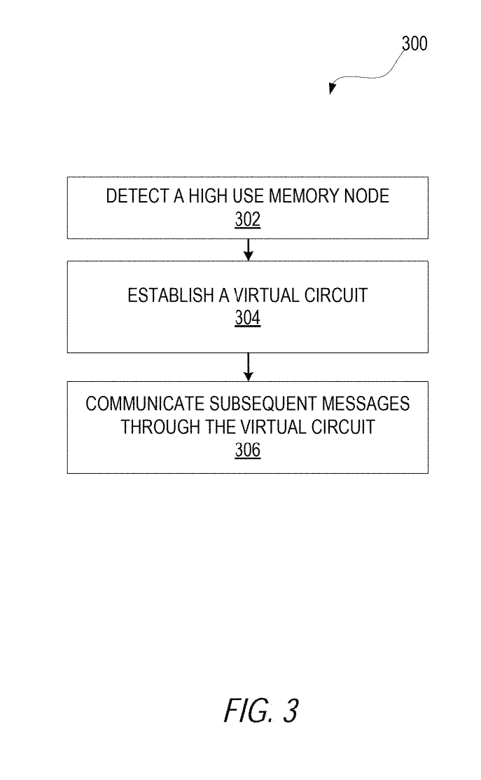

FIG. 3 is a flowchart illustrating a method 300 for dynamically establishing a virtual circuit during run-time execution of a node-based computing device 100, according to an example. Similar to the method 200 of FIG. 2, the method 300 may be performed by the modules, logic, components, or systems shown in FIG. 1 and, accordingly, is described herein merely by way of reference thereto. It will be appreciated that the method 300 may, however, be performed on any suitable hardware.

The method 300 may begin at operation 302 when the processor-side memory controller 111a detects that a memory node may be a high use memory node. A high use memory node may refer to a memory node that is likely to be the destination of subsequent memory access messages. A number of techniques can be used to signal that a communication path will be high use path. In some cases, the instruction set architecture (“ISA”) of the processor node 110a can provide explicit instructions for a programmer/compiler to signal that memory access to a given region (e.g., memory address, data structure, memory node) should be optimized by the processor-side memory controller entity and the node-based computing device. The ISA may also have an instruction to disable a memory address as a high use path.

In other cases, a node-based computing device 100 can predict when a region or path to a memory node should be optimized. For example, the processor-side memory controller can make such predictions by using performance counters that create a virtual circuit after a rate of activity within a time frame exceeds a threshold amount, and then disables a virtual circuit after a rate of inactivity within a time frame exceeds a threshold amount. The performance counters may be specific to messages being sent to a given address (or range of addresses) or a given memory node. These predictions could detect so called hot zones and cold zones within the node-based computing device in a manner that does not involve programmer or compiler assistance.

Upon detecting the high use memory node, the processor-side memory controller 111a may then, at operation 304, establish a virtual circuit between the processor node 110a and the high use memory node. With virtual circuits, the processor-side memory controller 111a can also apply DVFS on different virtual channels in the node-based computing device to ensure that power is favorably delivered to the memory nodes and links with high priority virtual channels, ensuring that important messages are delivered in time to meet the QoS goals. In an example, the node-based computing device can have a power budget, and DVFS can be applied to speed up the virtual circuits by boosting the voltage and/or frequency of the links and nodes in those circuits. The power budget is maintained by adjusting the voltage and/or frequency of other paths in the node-based computing device. Thus, the speed of the connections in the node-based computing device can vary while maintaining an overall energy budget. Note that applying DVFS in memory nodes and point-to-point links may lead to asynchronous network designs. To solve this problem, memory nodes can include buffers to allow for additional packet/message buffering at each node to compensate for the slower rates.

With continued reference to FIG. 3, at operation 306, the processor-side memory controller 111a may then transmit subsequent messages destined to the high use memory node via the virtual circuit. The memory-side controllers of the memory nodes 130a-i may manage the routing of messages between the processor node 110a and the memory node in accordance to the virtual circuit established at operation 304.

As described above, in some cases applying DVFS may lead to asynchronous network designs. Also described above, some implementations of the memory-side memory controllers may include storage buffers to allow for the memory-side memory controllers to buffer incoming messages at varying (e.g., slower) rates.

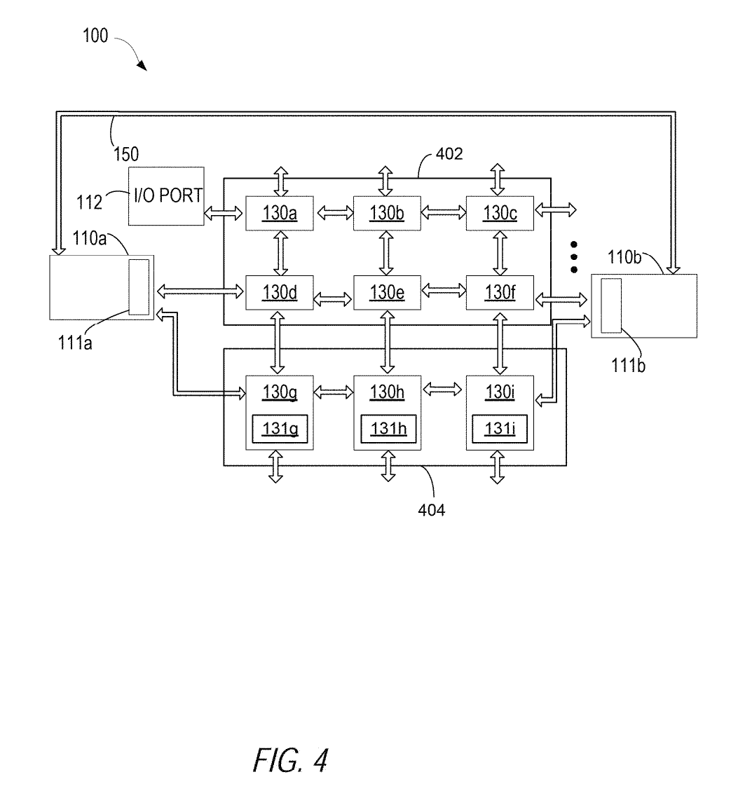

An additional option to ease the asynchronous challenges is to partition the node-based computing device into different voltage and frequency domains. Approaches adopting voltage and frequency domains can reduce the degree of asynchrony that each channel of a point-to-point link could potentially observe. In these designs, DVFS is applied to a voltage and frequency domain rather than the node-based computing device as a whole. FIG. 4 is a diagram showing the node-based computing device 100 of FIG. 1 with voltage and frequency domains 402, 404, according to an example. A voltage and frequency domain (such as voltage and frequency domains 402, 404) may be a sub-set of the memory nodes of the node-based computing device in which a virtual circuit can be formed. Further, a processor-side memory controller may apply DVFS to the memory nodes of a voltage and frequency domain. Thus, in some cases, the performance of a path in one voltage and frequency domain can be optimized by increasing the energy used by that path and then lowering the frequency/voltage used by other paths in that voltage and frequency domain. In this way, optimizing a path in one voltage and frequency domain does not affect the operation of paths in other voltage and frequency domains.

Some voltage and frequency domains may include buffers that are optimized for a range of DVFS values. Thus, one domain may include buffers of greater sizes than the buffers found in other domains to accommodate a greater step down in speed. Furthermore, other domains may not allow DVFS and are therefore optimized for a single frequency/voltage model. This hybrid/nonhomogeneous configuration can balance runtime flexibility and design time ease.

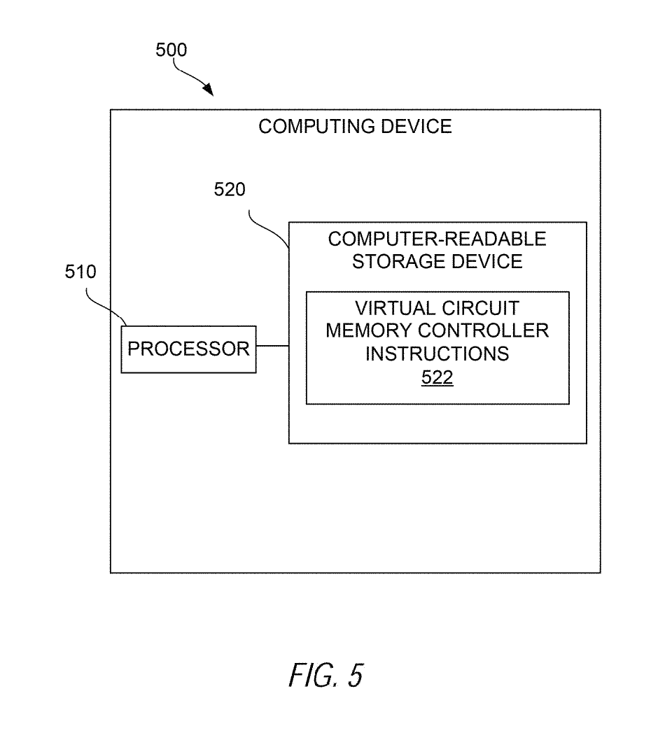

FIG. 5 is a block diagram of a computing device 500 capable of communicating data using a virtual circuit, according to one example. The computing device 500 includes, for example, a processor 510, and a computer-readable storage device 520 including virtual circuit memory controller instructions 522. The computing device 500 may be, for example, a memory node, a processor node, (see FIG. 1) or any other suitable computing device capable of providing the functionality described herein.

The processor 510 may be a central processing unit (CPU), a semiconductor-based microprocessor, a graphics processing unit (GPU), other hardware devices or circuitry suitable for retrieval and execution of instructions stored in computer-readable storage device 520, or combinations thereof. For example, the processor 510 may include multiple cores on a chip, include multiple cores across multiple chips, multiple cores across multiple devices, or combinations thereof. The processor 510 may fetch, decode, and execute one or more of the virtual circuit memory controller instructions 522 to implement methods and operations discussed above, with reference to FIGS. 1-4. As an alternative or in addition to retrieving and executing instructions, processor 510 may include at least one integrated circuit (“IC”), other control logic, other electronic circuits, or combinations thereof that include a number of electronic components for performing the functionality of virtual circuit memory controller instructions 522.

Computer-readable storage device 520 may be any electronic, magnetic, optical, or other physical storage device that contains or stores executable instructions. Thus, computer-readable storage device may be, for example, Random Access Memory (RAM), an Electrically Erasable Programmable Read-Only Memory (EEPROM), a storage drive, a Compact Disc Read Only Memory (CD-ROM), non-volatile memory, and the like. As such, the machine-readable storage device can be non-transitory. As described in detail herein, computer-readable storage device 520 may be encoded with a series of executable instructions for communicating message data through a node-based computing device using a virtual circuit.

As used herein, the term “computer system” may refer to one or more computer devices, such as the computer device 500 shown in FIG. 5. Further, the terms “couple,” “couples,” “communicatively couple,” or “communicatively coupled” is intended to mean either an indirect or direct connection. Thus, if a first device, module, or engine couples to a second device, module, or engine, that connection may be through a direct connection, or through an indirect connection via other devices, modules, logic, engines and connections. In the case of electrical connections, such coupling may be direct, indirect, through an optical connection, or through a wireless electrical connection.

While this disclosure makes reference to some examples, various modifications to the described examples may be made without departing from the scope of the claimed features.

What is claimed is:

1. A node-based computing device comprising:
a first processor node and a second processor node;
memory nodes that each include local memory that collectively form a main memory address space of the node-based computing device;
point-to-point links communicatively coupling the memory nodes to the first processor node, the memory nodes to the second processor node, and the memory nodes to each other; and
the second processor node including a processor-side memory controller to:
establish a virtual circuit between the first processor node with the second processor node, the virtual circuit dedicating a path through the memory nodes, and
communicate a cache coherency message to the first processor node using the path dedicated through the virtual circuit.

2. The node-based computing device of claim 1, wherein the processor-side memory controller further to communicate a memory access message to one of the memory nodes.

3. The node-based computing device of claim 2, wherein the memory nodes further to communicate the memory access message to the one of the memory nodes using connectionless packet switching.

4. The node-based computing device of claim 2, wherein the processor-side memory controller message to communicate the cache coherency message and the memory access message to the memory nodes through the same point-to-point link.

5. The node-based computing device of claim 1, wherein the processor-side memory controller further to communicate an input output message to one of an input output port through the memory nodes using connectionless packet switching.

6. The node-based computing device of claim 1, wherein the processor-side memory controller further to apply dynamic voltage and frequency scaling to increase the voltage and frequency of the path dedicated through the virtual circuit.

7. The node-based computing device of claim 1, wherein the processor-side memory controller further to apply dynamic voltage and frequency scaling to decrease the voltage and frequency of paths other than the path dedicated through the virtual circuit.

8. The node-based computing device of claim 7, wherein a degree of the decrease is relative to a power budget of the memory nodes.

9. The node-based computing device of claim 7, wherein the processor-side memory controller further to select the paths based on the paths belonging to a voltage and frequency domain.

10. The node-based computing device of claim 1, wherein the processor-side memory controller further to establish the virtual circuit during a startup phase of the node-based computing device.

11. A method comprising:
detecting, by a processor node, a high use memory node, the high use memory node being a memory node of a plurality of memory nodes communicatively coupled to the processor node, the plurality of memory nodes forming an addressable memory space for the processor node;
establishing a virtual circuit that dedicates a communication path from the processor node of the high use memory node; and
communicating subsequent messages through the virtual circuit, the memory nodes forwarding the subsequent messages according to the dedicated path.

12. The method of claim 11, wherein detecting the high use memory node comprises executing an instruction set architecture instruction that requests establishment of the virtual circuit.

13. The method of claim 11, wherein detecting the high use memory node comprises determining that a rate of activity associated with the high use memory node exceeds a threshold amount.

14. The method of claim 13, further comprising closing the virtual circuit based on determining that a rate of inactivity associated with the high use memory node exceeds a threshold amount.

15. A computer-readable storage device comprising instructions that, when executed, cause a processor of a computing device to:
detect a memory node from a plurality of memory nodes as a high use memory node, the plurality of memory nodes forming an addressable memory space for the processor;
establish a virtual circuit that dedicates a communication path from the processor node of the high use memory node; and
communicate subsequent messages to the high use memory node through the virtual circuit.
